(19) United States
(12) Patent Application Publication
(10) Pub. No.: US 2011/0113916 A1
(43) Pub. Date: May 19, 2011

(54) ARM ASSEMBLY AND ROBOT USING THE SAME

(75) Inventor: BO LONG, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/859,418

(22) Filed: Aug. 19, 2010

(30) Foreign Application Priority Data
Nov. 18, 2009 (CN) 200910309912.6

(51) Int. Cl. B25J 18/00

(52) U.S. Cl. 74/490.01

(57) ABSTRACT

An arm assembly for a robot includes a connecting member and a supporting member fixed on the connecting member. The connecting member defines a first cavity therethrough along an axis of the connecting member. The supporting member defines a second cavity communicating with the first cavity of the connecting member.

### BACKGROUND

1. Technical Field

The present disclosure relates to an arm assembly and, particularly, to an arm assembly used in a robot, and a robot using the same.

2. Description of the Related Art

A commonly used robot includes an upper arm for mounting an end executor. The upper arm generally has a complex shape to position the end executor accurately, resulting in difficulties when manufacturing the upper arm precisely by molding.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views, and both the views are schematic.

FIG. 1 is an isometric view of an embodiment of a robot including an arm assembly.

FIG. 2 is an isometric view of a first embodiment of an arm assembly.

FIG. 3 is an exploded, isometric view of the arm assembly shown in FIG. 2.

FIG. 4 is a cross sectional view of the arm assembly shown in FIG. 2, taken along the line IV-IV.

FIG. 5 is an exploded, isometric view of a second embodiment of an arm assembly.

FIG. 6 is a cross sectional view of the arm assembly shown in FIG. 5.

### DETAILED DESCRIPTION

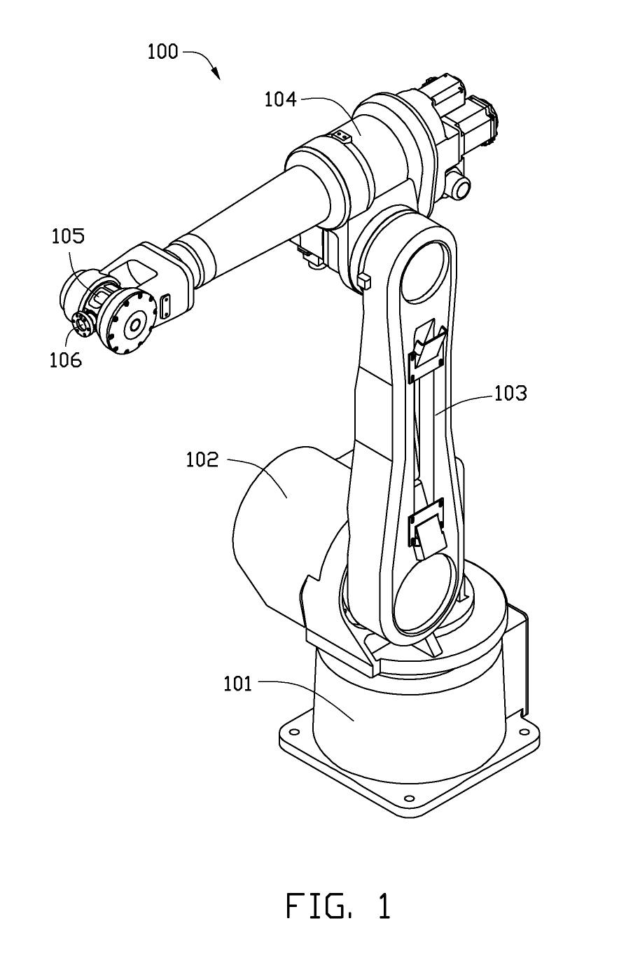

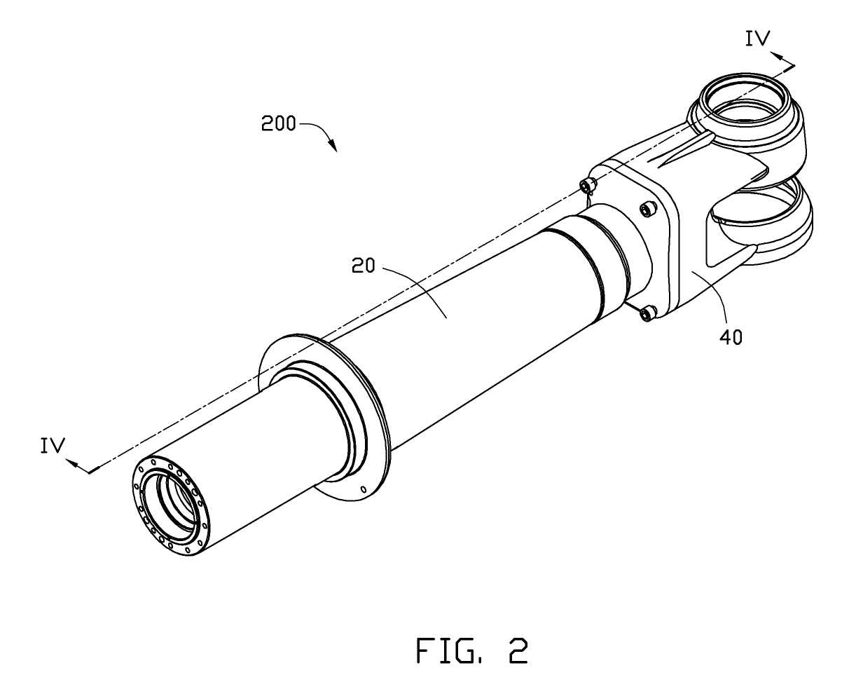

Referring to FIG. 1, an exemplary embodiment of a robot 100 includes a base 101, a bracket 102 rotatably mounted on the base 101, a lower arm 103 rotatably positioned on the bracket 102, a connecting arm 104 and an upper arm 105. The connecting arm 104 rotatably interconnects the lower arm 103 and the upper arm 105. The upper arm 105 includes an arm assembly 200, a driving assembly (not shown) received in the arm assembly 200 (shown in FIG. 2) and a rotation assembly 106 mounted at an end of the arm assembly 200 away from the connecting arm 104. The robot 100 may further include an end executor (not shown) positioned on the rotation assembly 106.

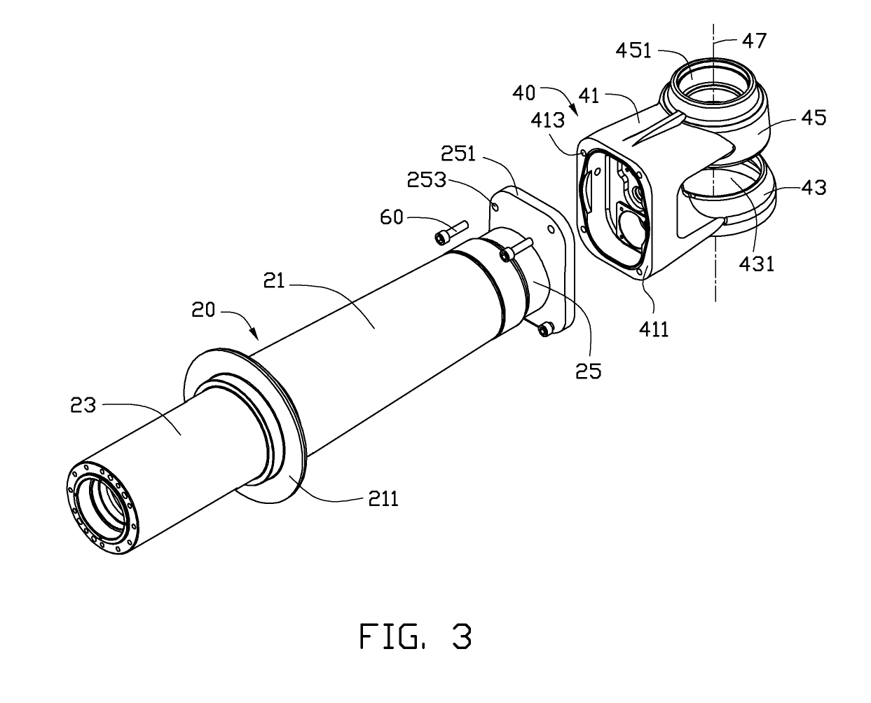

As shown in FIGS. 2 and 3, a first embodiment of the arm assembly 200 includes a connecting member 20 and a support member 40 fixed at an end of the connecting member 20. The connecting member 20 is substantially a revolution solid extending along a central axis or line. The connecting member 20 includes a main body 21, a first connecting portion 23 formed at an end of the main body 21 and a second connecting portion 25 formed at the other end of the main body 21. A diameter of the main body 21 is gradually decreased along a direction toward the second connecting portion 25. The first connecting portion 23 is substantially a sleeve for mounting on the connecting arm 104. The first connecting portion 23 forms a locating flange 211 at an outer surface thereof. The second connecting portion 25 forms a mounting flange 251 at the end away from the first connecting portion 23 for connecting or fixing to the supporting member 40. The mounting flange 251 defines a plurality of fixing holes 253.

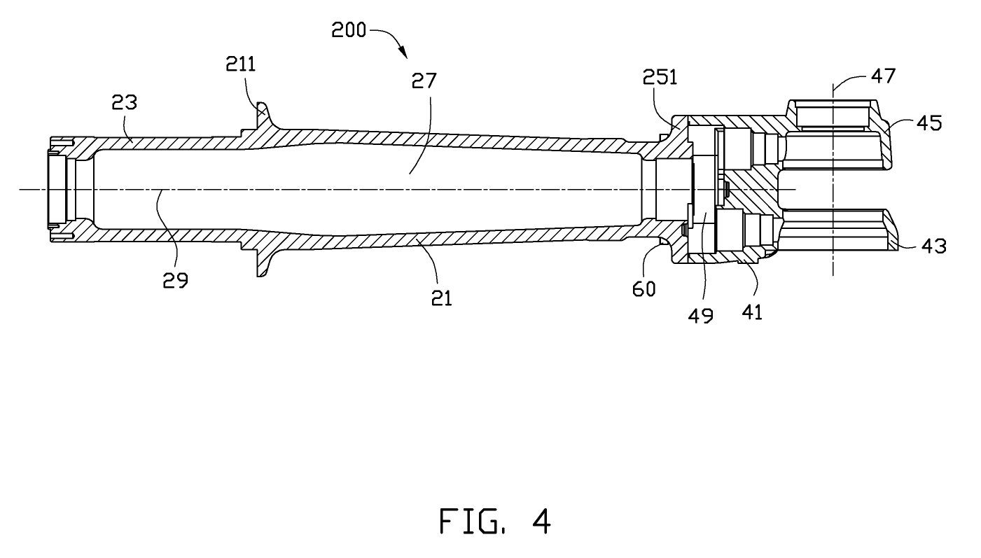

As shown in FIG. 4, the connecting member 20 is symmetrical relative to a central line 29 thereof. The connecting member 20 is hollow. The connecting member 20 defines a first cavity 27 therein passing through the connecting member 20, allowing a plurality of cables to pass through the connecting member 20, and a weight of the connecting member 20 is also reduced.

The supporting member 40 is substantially U-shaped and includes a base portion 41, a first supporting portion 43 and a second supporting portion 45. The first supporting portion 43 and the second supporting portion 45 are formed at a side surface of the base portion 41, and spaced from each other. The base portion 41 of the supporting member 40 is substantially rectangular, and forms a contacting surface 411 corresponding to the mounting flange 251 at another surface away from the first supporting portion 43 and the second supporting portion 45. The supporting member 40 defines a plurality of threaded holes 413 at the contacting surface 411 corresponding to the fixing holes 253 of the mounting flange 251. A fastener 60 can pass through the fixing hole 253 and can be received in the threaded hole 413, to fix the supporting member 40 on the mounting flange 251. Both the first supporting portion 43 and the second supporting portion 45 define a circular mounting hole 431, 451 with the same axis 47. The rotation assembly 106 can be disposed between the first supporting portion 43 and the second supporting portion 45, and can rotate around the axis 47. The base portion 41 defines a second cavity 49 for receiving the driving assembly. When the supporting member 40 is mounted on the mounting flange 251, the second cavity 49 communicates with the first cavity 27 of the connecting member 20.

The connecting member 20 and the supporting member 40 may be made of high strength and light weight material, such as cast aluminum or aluminum alloys. In the illustrated embodiment, the connecting member 20 and supporting member 40 are made by sand casting mold. Alternatively, the connecting member 20 and the supporting member 40 may be made by permanent mold or lost pattern casting mold. A method of fabricating the connecting member 20 follows

In step 1, a first sand casting mold is provided. The sand casting mold includes a female mold and a male mold corresponding thereto. The male mold has a core therein corresponding to the first cavity 27 of the connecting member 20. Each of the two ends of the core forms a supporting portion. The female mold defines a receiving groove at each side for receiving each of the supporting portion, respectively.

In step 2, the core is fixed in the female mold and each supporting portion is received in each receiving groove. The male mold is mated with the female mold to form a cavity comprising the shape of the connecting member 20.

In step 3, molten metal material is injected into the sand casting mold, and cooled; and the connecting member 20 is then formed. The metal material may be cast aluminum or aluminum alloys.

It is understood that the supporting member 40 may also be fabricated according to the method disclosed.

The connecting member 20 as a solid of a simpler symmetrical shape, is easily designed and manufactured. The upper arm 105 is divided into the connecting member 20 and the supporting member 40, and the connecting member 20 and the supporting member 40 can be molded individually, thus manufacturing precision of the upper arm 105 can be optimized.

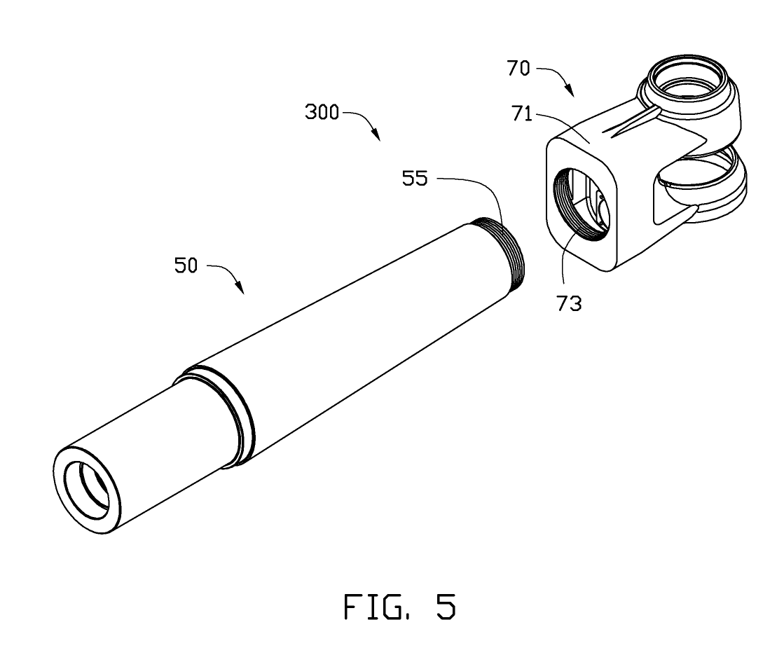

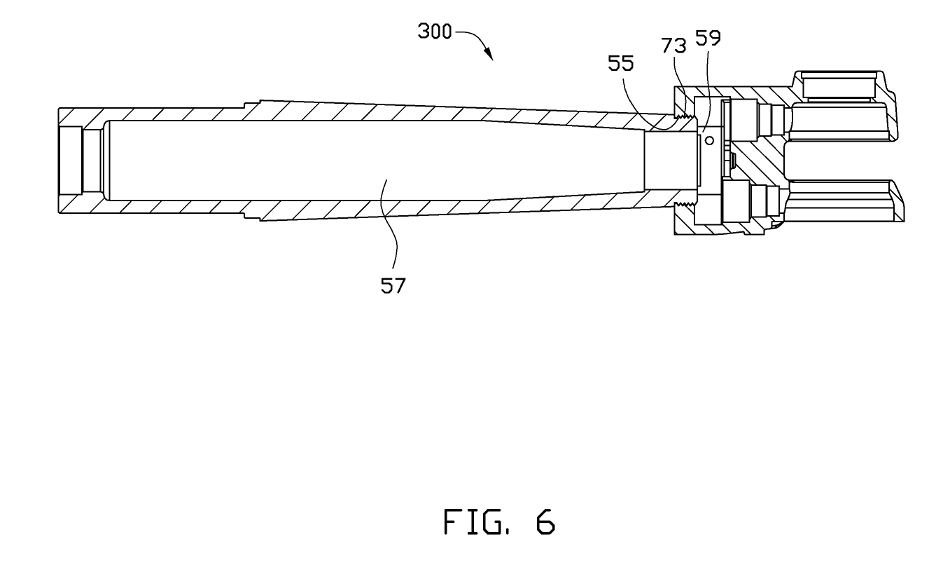

As shown in FIGS. 5 and 6, a second embodiment of an arm assembly 300 is similar to the arm assembly 200, differing only in that the connecting member 50 forms a threaded portion 55 and the main body 71 of the supporting member 70 defines a threaded hole 73 corresponding thereto. The threaded portion 55 is received in the threaded hole 73, to fix the supporting member 70 on the connecting member 50, and a first cavity 57 of the connecting member 50 communicates with the second cavity 59 of the supporting member 70.

Finally, while particular embodiments have been described, the description is illustrative and is not to be construed as limiting. For example, various modifications can be made to the embodiments by those of ordinary skill in the art without departing from the true spirit and scope of the invention as defined by the appended claims.

What is claimed is:

1. An arm assembly for a robot, the arm assembly comprising:
a connecting member defining a first cavity therethrough along a central axis thereof; and
a supporting member fixed on the connecting member, the supporting member defining a second cavity communicating with the first cavity of the connecting member.

2. The arm assembly of claim 1, wherein the connecting member forms a mounting flange at an end thereof, and the mounting flange fixed on the supporting member.

3. The arm assembly of claim 2, wherein the connecting member comprises a main body, a first connecting portion formed at an end of the main body for mounting an end executor and a second connecting portion formed at the other end of the main body, wherein the mounting flange is formed at the second connecting portion, and a diameter of the main body gradually decreases toward the mounting flange.

4. The arm assembly of claim 1, wherein the connecting member forms a threaded portion at an end; the supporting member defines a threaded hole corresponding to the threaded portion, and the supporting member is fixed on the connecting member by the threaded portion received in the threaded hole.

5. The arm assembly of claim 1, wherein the connecting member is symmetrical relative to a central line thereof.

6. The arm assembly of claim 1, wherein the supporting member further comprises a first supporting portion and a second supporting portion at a side surface, wherein both the first supporting portion and the second supporting portion define a mounting hole for fixing an end executor.

7. A robot comprising:
a base;
a bracket rotatably positioned on the base;
a lower arm rotatably positioned on the bracket; and
a connecting arm rotatably interconnects the lower arm and an upper arm,
, wherein the upper arm comprises an arm assembly, the arm assembly comprising a connecting member defining a first cavity therethrough along an axis thereof; and a supporting member fixed on the connecting member, and the supporting member defining a second cavity communicating with the first cavity of the connecting member.

8. The robot of claim 7, wherein the connecting member forms a mounting flange at an end thereof, and the mounting flange fixed on the supporting member.

9. The robot of claim 8, wherein the connecting member comprises a main body, a first connecting portion formed at an end of the main body for mounting an end executor and a second connecting portion formed at the other end of the main body, the mounting flange is formed at the second connecting portion, and a diameter of the main body gradually decreases toward the mounting flange.

10. The robot of claim 7, wherein the connecting member forms a threaded portion at an end; the supporting member defines a threaded hole corresponding to the threaded portion, and the supporting member is fixed on the connecting member by the threaded portion received in the threaded hole.

11. The robot of claim 7, wherein the connecting member is symmetrical relative to a central line thereof.
